(19) United States
(12) Patent Application Publication
(10) Pub. No.: US 2008/0028284 A1
(43) Pub. Date: Jan. 31, 2008

(54) System and method for web-based interactive gathering hyperlinks and email addresses

(75) Inventor: YAN KUEI CHEN, BURTONSVILLE, MD (US)

Correspondence Address: Mr.YAN KUEI CHEN, 3100 HUNT FARM CT, BURTONSVILLE, MD, 20866, US

(73) Assignee: WASHINGTON TRANS WORLD TECHNOLOGIES LLC, SILVER SPRING, MD (US)

(21) Appl. No.: 11/309,351

(22) Filed: Jul. 30, 2006

(51) Int. Cl. G06F 17/00

(52) U.S. Cl. 715/205; 715/208; 715/207

(57) ABSTRACT

The invention is an application to interact with user and concurrently extract titles, descriptions and emails from the web page pointed by a list of URLs. The user can directly input a list of URLs, or alternatively, a location that contains a list of URLs. The system will generate link texts and email messages; the user evaluates and edits the automatically generated results and submits the data to be formatted for web page, saved into a file, sent as email, or inserted into database.

### BACKGROUND OF THE INVENTION

World Wide Web is a system of Internet servers that support specially formatted documents in a markup language call HTML (Hyper Text Markup Language) that support links to other documents. Usually, if a web designer wishes to create a hyperlink to a web page, the designer needs to manually compose each URL, title and description. Once the link is created, the designer sometimes sends out an email message to notify the webmaster or request a reciprocal link exchange.

Accordingly, what is needed is an interactive service to help web designers search selected sites, then automatically generate link texts and/or a customized email messages.

### DEFINITIONS

### Definition List 1

| Term | Definition |
|---|---|
| Link or Hyperlink | A link is a reference in hypertext |
| | document to another document or other |
| | resource. Links are specified in HTML |
| | using the <a> (anchor) elements. |
| Internal link | A link to a page inside the same domain |
| | is called Internal link. |
| External link | A link to a page outside the same |
| | domain is called External link. |
| URL or Uniform | As used here, is a sequence of |
| Resource Locator | characters, conforming to a standardized |
| | format that is used to refer to a |
| | resource, such as a document or an |
| | image on the Internet, by their locations. |

### SUMMARY OF THE INVENTION

The present invention provides a system for users to interactively extract links, titles, descriptions and/or emails from multiple sources. The feature maybe embodied alone or in combination with a login interface, link exchange software, link directory creation software, link management software or another type of software.

One method aspect of the invention includes the user manually inputs a list of URLs and submits the input to the Parallel Links Analyzer (FIG. 2) for processing.

Another method aspect includes an alternative method of input which the user manually inputs one URL that points to a web page or another resource that contains a list of URLs to be analyzed. The system receives the URL, fetches and filters the webpage pointed by the URL to extract the external links to produce a list of URLs. Then, the list of the URLs is sent to the Parallel Links Analyzer (FIG. 2).

The Parallel Links Analyzer (FIG. 2) receives the list of URLs as the input, concurrently fetches the web page corresponding to each URL to extract title, description and email, and then outputs the result to be formatted for end user editing.

The Output Processor (FIG. 6) where the system receives the edited data and processes it for various uses.

### BRIEF DESCRIPTION OF THE FIGURES

FIG. 1 presents an overview of the system in accordance with the present invention.

FIG. 2 illustrates the Parallel Links Analyzer which is used to process multiple URLs concurrently.

FIG. 3 illustrates a flow diagram of the URL analyzer which is a component of Parallel Links Analyzer.

FIG. 4 illustrates the Parallel Email Processor that is used to fetch email addresses. Either the Parallel Email Processor or Serial Email Processor can be used in the URL analyzer.

FIG. 5 illustrates the Serial Email Processor that can be used as a substitute for the Parallel Email Processor.

FIG. 6 illustrates an Output Processor that is used to process the output for the system.

FIG. 7 illustrates the user input in FIG. 1, step 100 and 101.

FIG. 8 illustrates the user editing data method in FIG. 1, step 107.

FIG. 9 illustrates the notification method in FIG. 1, step 109.

### DETAILED DESCRIPTION OF THE PREFERED EMBODIMENTS

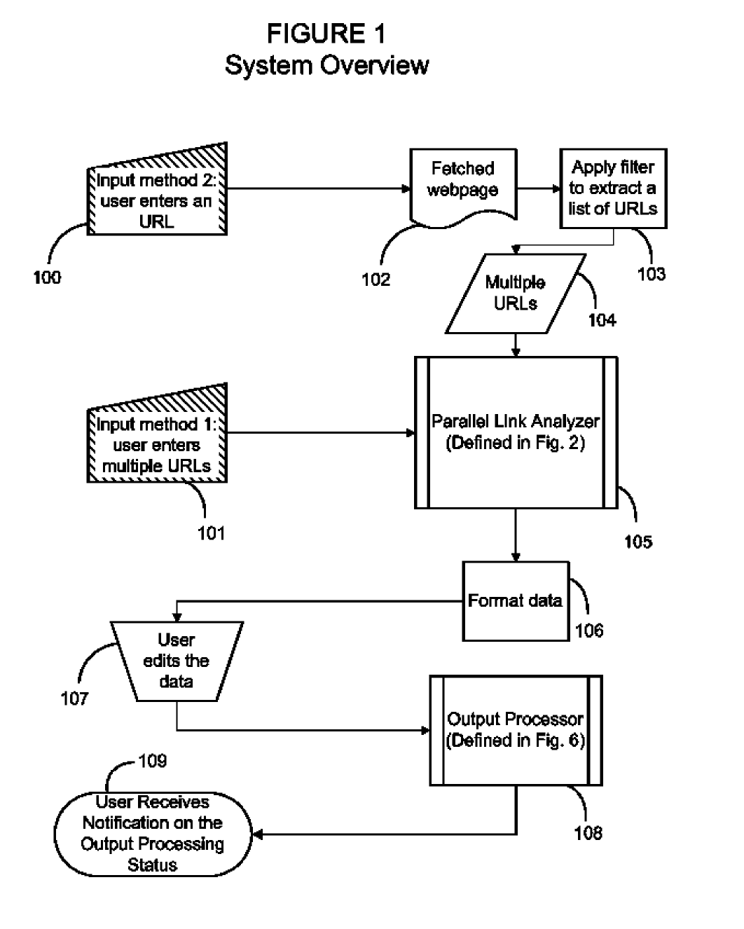

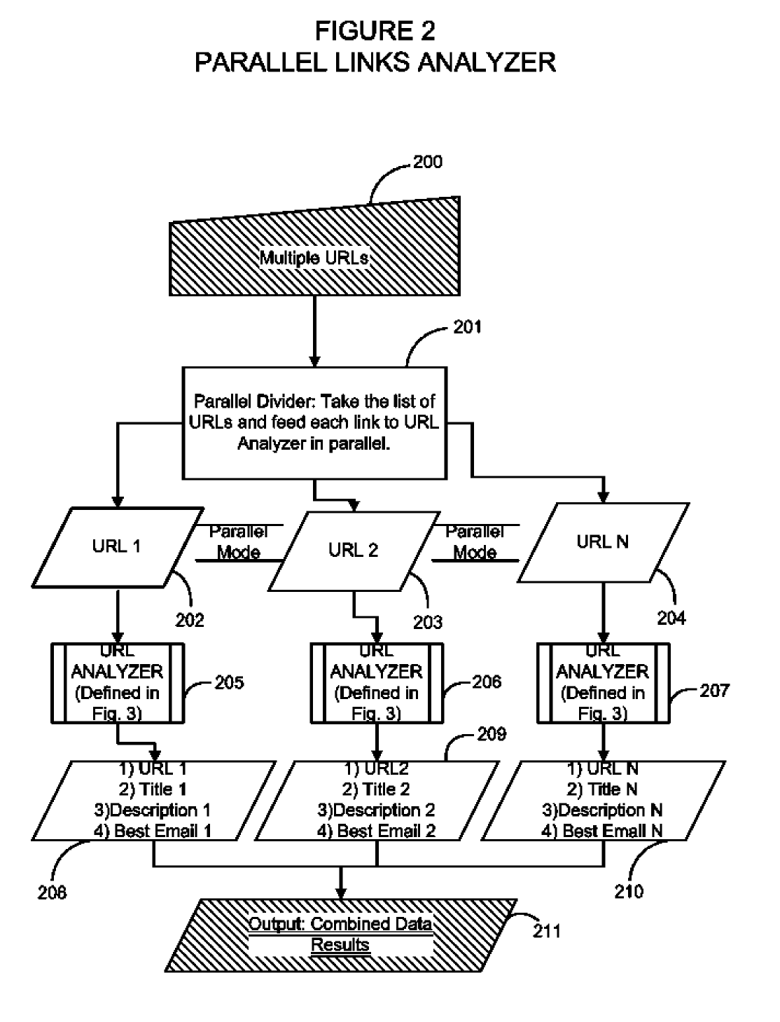

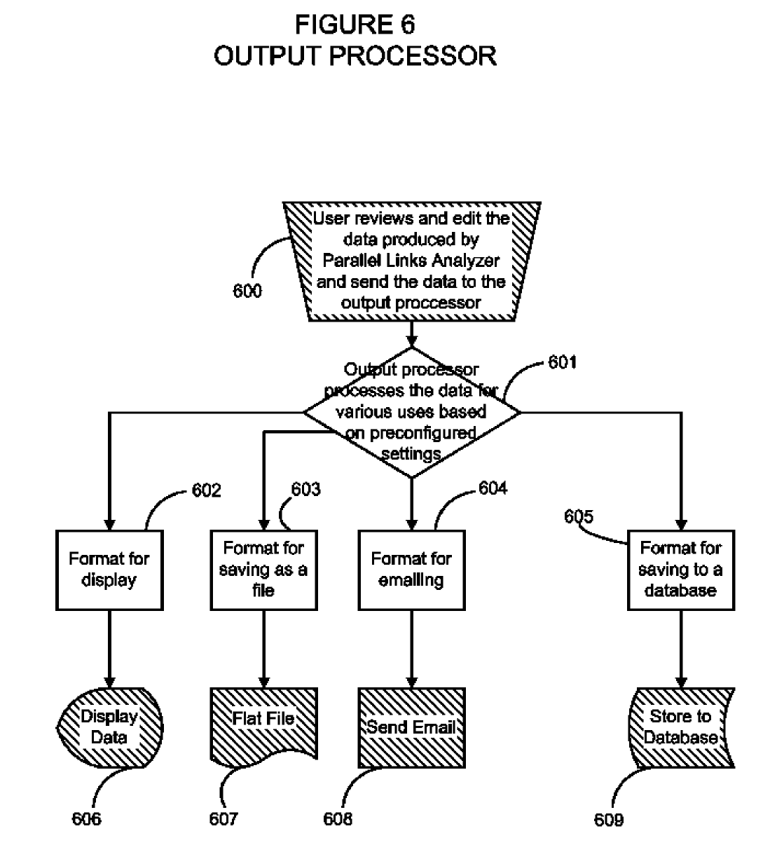

FIG. 1 presents an overview of the system. There are two methods for input into the system: The first method 100 of input is feeding a list of URLs directly into the Parallel Links Analyzer 105 for processing. The second method 101 of input is submitting an URL pointing to a web page that contains a list of URLs to be analyzed; the content of the web page will be fetched; then, a filter 103 will extract the external URLs to feed into the Parallel Links Analyzer 105 (FIG. 2). Once the Parallel Links Analyzer 105 receives the input, it concurrently fetches the content of the web pages pointed by the URLs. Then, the web pages are filtered to extract titles, descriptions and email addresses. The output from the Parallel Links Analyzer 105 will be formatted for display 106 and presented to the client system for user editing 107. After the user edits the data, the result is sent back to the system to be processed by the Output Processor 108 (FIG. 6). When the Output Processor finish processing the data, a notification is sent to the user 109.

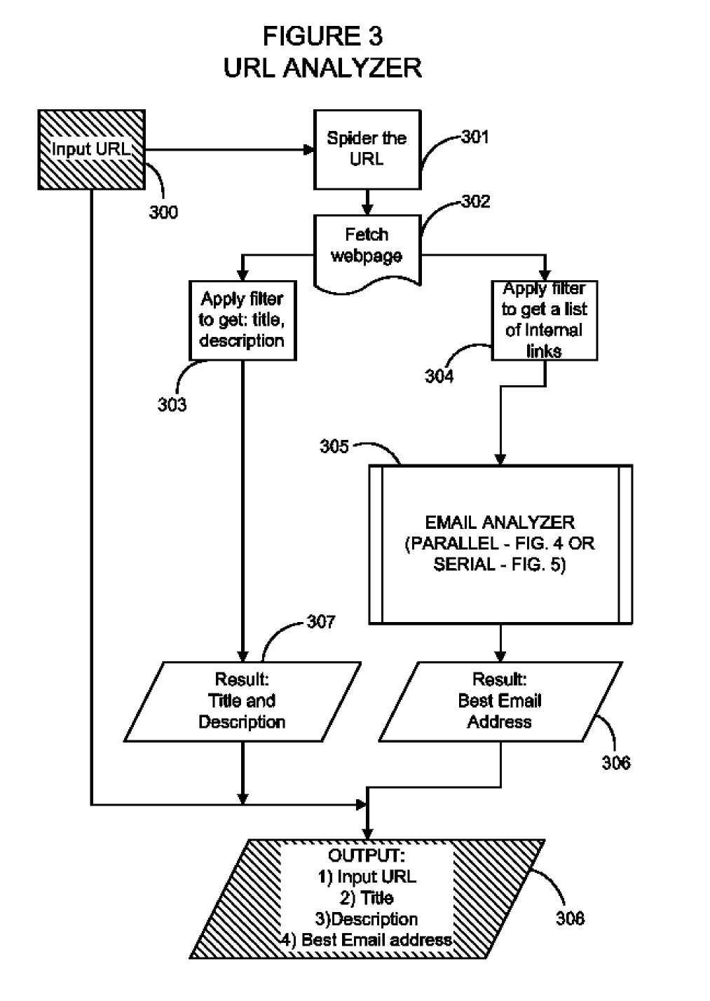

FIG. 2 illustrates the Parallel Links Analyzer 105 in detail. In the diagram, the Parallel Links Analyzer takes a list of links 200 and feeds each individual link in Parallel 201 to the URL Analyzer defined in the previous pages. Multiple instances of the URL Analyzer 205 206 207 process the input URLs in Parallel and output a result 208 209 210 corresponding to each input. When all instances of the URL analyzer finished processing the data, or a maximum execution time for URL analyzer set by the system elapsed, the system combines the results produced by the instances of URL Analyzer, and produces an output 211. The output 211 of the Parallel Links Analyzer is a list of elements where each element is produced by an instance of the URL Analyzer 205 206 207 (FIG. 3). The format of each element is: URL, title, description and contact email address of the website being analyzed.

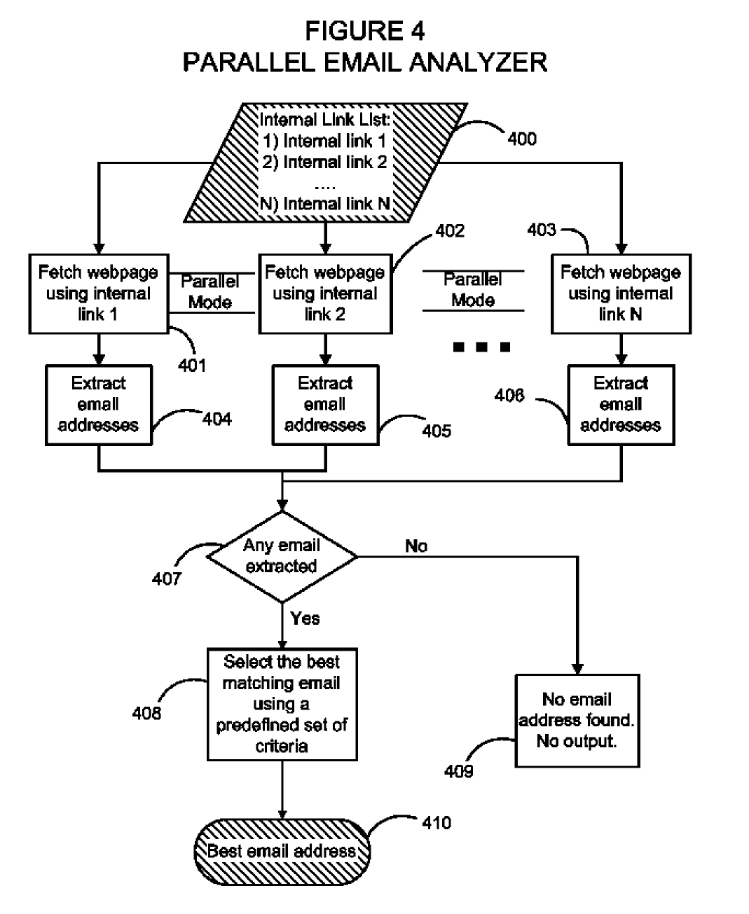

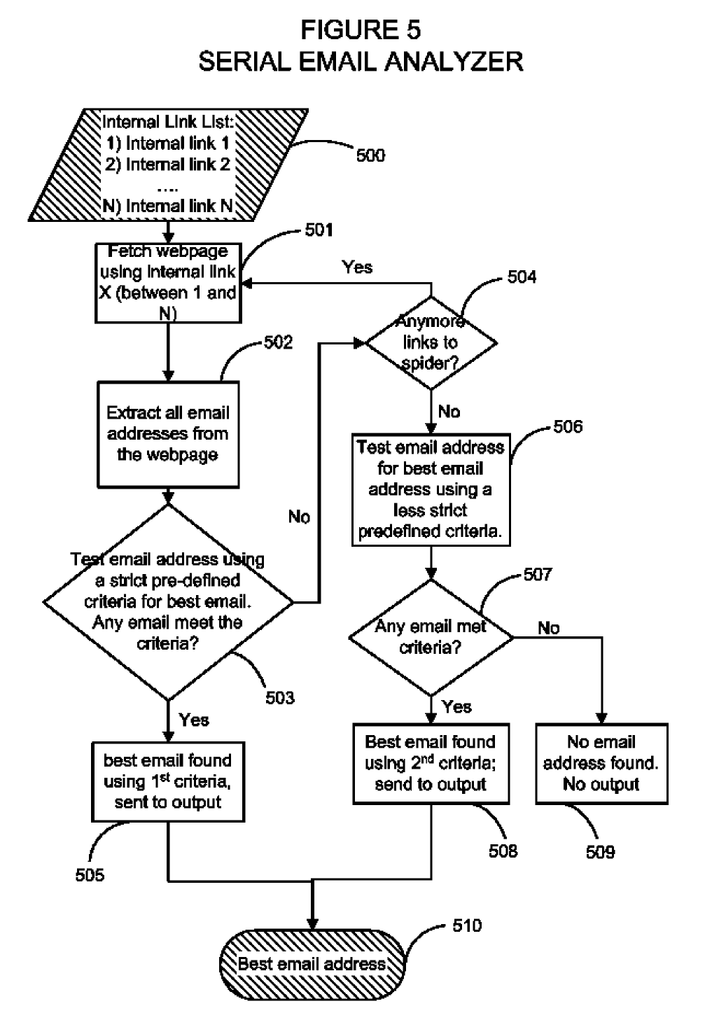

FIG. 3 illustrates the URL Analyzer 205 206 207 which is a component of the Parallel Links Analyzer 105 which takes a single URL 300 as input and produces an output 308 consists of: 1) URL 2) Title 3) Description and 4) Best email address. The output “URL” 308 is the input URL to the URL Analyzer. The “Title” 308 is filtered from the web page fetched corresponding to the URL. The “Description” 308 is also filtered from the URL. Finally, the best email address 308 is found by Parallel or Serial Email Analyzer 305 defined in FIG. 4 or FIG. 5. In the diagram, the URL analyzer receives an URL as input 300. Then, the URL analyzer fetches the web page's content 302 pointed by the URL. After that, a filter extracts the “Title” and “Description” from the web page to produce the first result 307. At the same time, the Parallel or Serial Analyzer fetches the email addresses and produces the best email address 306. Finally, the results are combined to yield an output 308.

FIG. 4 illustrates the Parallel Email Analyzer 305 which is a component of URL Analyzer. The input to the system is a list of URLs 400. When the analyzer receives the input 400, it will crawl each URL in parallel; the web page content fetched 401 402 403 will be filtered to produce a list of email address 404 405 406. If at least one email address is found 407, the email address or addresses will be tested with a set of criteria 408 to produce a best matching email 410 as the output. If the test criteria are not met, no output 409 will be produced.

FIG. 5 illustrates the Serial Email Analyzer 305 which is an alternative substitute for Parallel Email Analyzer which also takes a list of URLs as input 500. When the analyzer receives the input 500, it will crawl each URL one at a time 501 to extract email addresses 502 on the page. Every email address will be tested 503 for criteria such as domain name match as it is fetched. If test criteria for email are met during analyzing, loop exit 505 and the email address is sent to the output 510. Otherwise, the system continues to analyze the next URL 504. When all URLs are crawled and no email matches the first set of criteria, all emails gathered will be tested with a second set of criteria 506 which contains less restrictive rules to select a best email address 508 to send to the output 510. If no email meets the first or second test criteria, no output 509 will be produced.

FIG. 6 illustrates the Output Processor 108 of the system. The output from the Parallel Links Analyzer is sent to the user for editing 107. Then, the user sends the edited data back to the system 600 for processing using the Output Processor 601. The Output Processor 601 processes the data for different uses depending on preconfigured settings. Here is a few possible ways the output can be processed: 1) 602 the output may be formatted and displayed to the user monitor; 2) 603 the output may be formatted and saved as a file to the user's computer; 3) 604 the output maybe processed and sent out as email; 4) 605 the output may be stored to database.

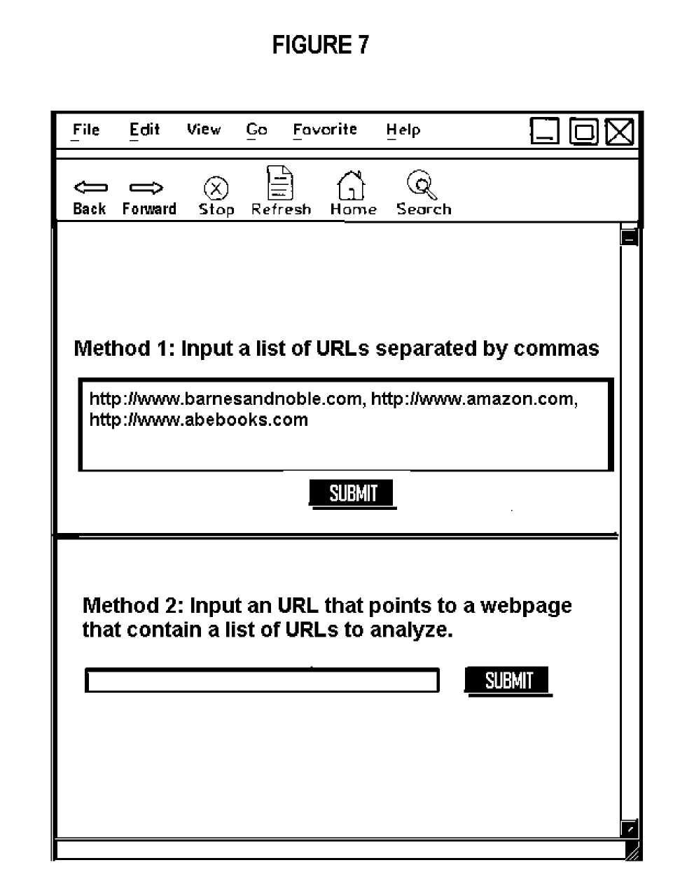

FIG. 7 illustrates general format of the system requesting input from the user. The user is given two choices for input: method 1 is presented in FIG. 1, number 100; method 2 is presented in FIG. 2, number 101.

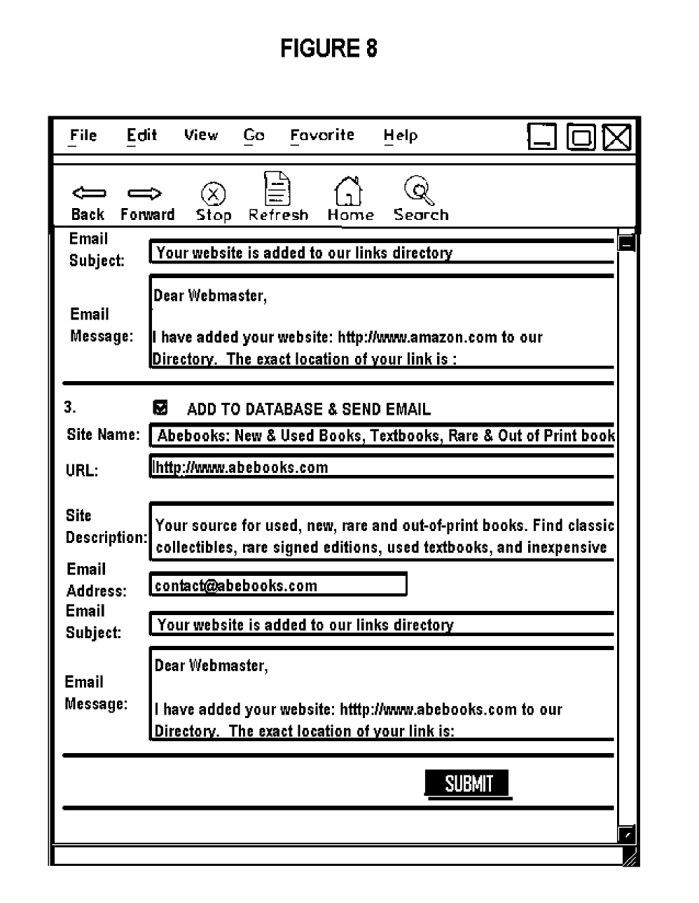

FIG. 8 illustrates general format of the system presenting data to the user for editing. Each text boxes are user editable. When the user finished editing, the “submit” button will send the edited data back to the system.

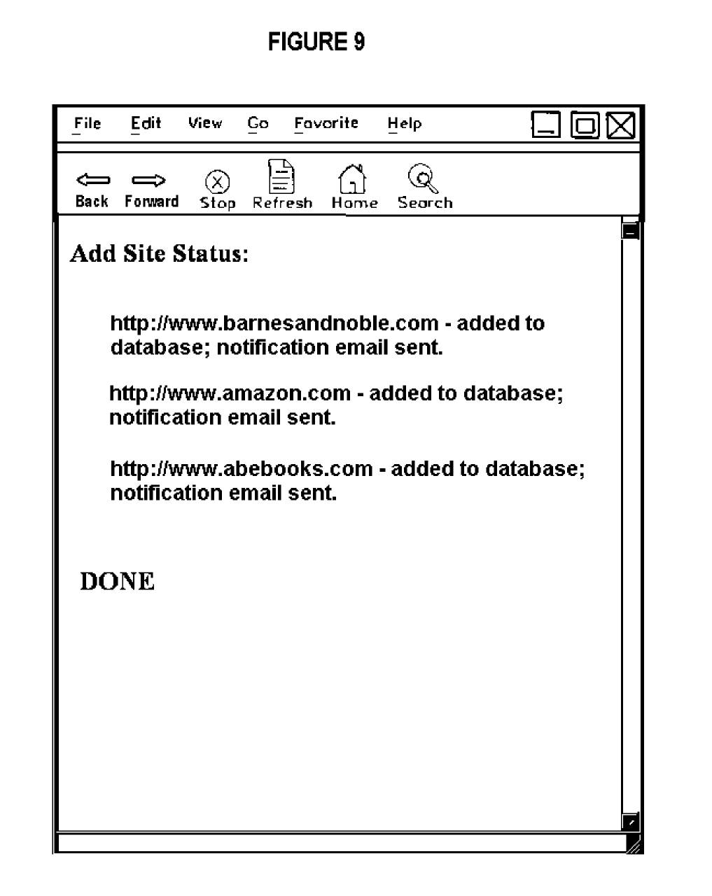

FIG. 9 illustrates the Output Processor where the system receives the edited data and processes it in one or more ways 108. Finally, the user is notified of the status 109.

What is claimed is:

1. A system to interactively generating hyperlinks comprising:
(a) Input means for user to send input to the system;
(b) Links analyzing means for concurrently fetching and analyzing a list of URLs;
(c) User editing means for the user to edit automatically generated results;
(d) Output processing means for processing data for various uses.

2. The method of claim 1 wherein (a) comprises input to the system that comes from a web browser resides on a personal computer linked to the internet.

3. The input method of claim 1 wherein (a) further comprises input to the system that is an URL that points to a resource containing multiple external URLs.

4. The input method of claim 1 wherein (a) further comprises input to the system that is a list of URLs for analyzing.

5. The system of claim 1 wherein (b) comprises a method to extract the best matching email addresses from the websites pointed by the input URLs in series or in parallel.

6. The method of claim 5 wherein the serial method exits the loop once a selected set of criteria is met.

7. The method of claim 5 further comprises the parallel method which exits automatically when all threads finish processing or when a maximum time is reached.

8. The system of claim 1 wherein (b) comprises filtering title and description from the web page pointed by the input URL.

9. The method of claim 8 wherein title and description filtering runs in parallel with email address extracting in claim 6.

10. The system of claim 1 wherein (c) comprises the links analyzer sending the result to the client for editing.

11. The system of claim 1 wherein (c) further comprises the client posting back the edited result to the system.

12. The system of claim 1 wherein (d) comprises an Output Processor that processes the output for various uses.

13. The system of claim 1 wherein (d) further comprises the Output Processor selecting a method to process the output based on system or user preference.

14. The system of claim 13 comprises an output which is processed for display to user.

15. The system of claim 13 further comprises the output which is processed for saving to a flat file on the hard drive in the user system.

16. The system of claim 13 further comprises the output which is processed as email messages and sent out to the email addresses of claim 8.

17. The system of claim 13 further comprises the output which is processed for storing to a database.

18. The system of claim 13 further comprises the output which is processed as input to another system for further processing.

19. The system of claim 13 wherein the output is processed with one or a combination of output processing methods in claim 14, 15, 16, 17 and 18.
